(19) United States
(12) Patent Application Publication
(10) Pub. No.: US 2012/0080427 A1
(43) Pub. Date: Apr. 5, 2012

(54) Self-Supporting Double Wall In Situ Tank System

(76) Inventor: David D. Russell, Blodgett, MO (US)

(21) Appl. No.: 13/252,828

(22) Filed: Oct. 4, 2011

Related U.S. Application Data
(60) Provisional application No. 61/389,606, filed on Oct. 4, 2010.

(51) Int. Cl. B65D 1/40; B23P 17/04

(52) U.S. Cl. 220/62.21; 29/401.1

(57) ABSTRACT

A liner, a double-walled tank including such a liner, and a method for retrofitting or creating such a liner wherein the liner is designed to be self-supporting. Specifically, the liner is formed by adding structures to the inner surface of an existing single-walled or double walled tank which project from the inner surface of the tank into the internal volume. The combination of the surfaces of the structures and the remaining inner surfaces of the tank form a modified inner surface which then has a liner placed adjacent thereto. The liner is hardened or other fixed in form to provide for an internal liner which retains negatives of the shapes of the structures and is capable of resisting deformation should the original tank be removed and the liner be filled with material that originally would occupy the tank.

### CROSS REFERENCE TO RELATED APPLICATION(S)

This application claims benefit of and priority to U.S. Provisional Application Ser. No. 61/389,606 filed Oct. 4, 2010, the entire disclosure of which is herein incorporated by reference.

### BACKGROUND

1. Field of the Invention

This disclosure relates to the field of tank liners that can be used to retrofit an existing single wall underground storage tank into a double walled storage tank, a method of making such a liner and a tank which utilizes such a liner where the liner is shaped by the inclusion of internal structures in the tank to alter its shape and improve its strength.

2. Description of the Related Art

Commercial and industrial liquids of all types are stored in underground storage tanks. These tanks are generally cylindrical in shape and usually have a capacity in the range of 500 to 20,000 gallons or more. Such tanks are generally made of either metal (usually steel) or a fiber reinforced resinous material.

Because the liquids stored in these underground tanks are often hazardous (gasoline for use as a motor fuel being one of the most common), and thus can cause severe environmental damage and greatly impact the lives of people living, working, and recreating in nearby areas, careful attention to the potential for leaks from such tanks must be exercised. Due to these potential problems from leaks, safer storage tanks have been designed with a double wall, such that a breach in the integrity of either of the inner or outer wall alone will not allow a leak of the liquid contained in the tank. The use of such double-walled tanks (or equivalents thereof, wherein some sort of secondary containment mechanism, such as a liner, provided for an otherwise single-walled tank) is increasingly being mandated by government regulations.

In one alternative of an underground tank structure that provides added safety from the hazards of leaking storage tanks, a liner is installed in a single wall tank that has been in use and is already in the ground. Certain of these liners can be installed without removing the tank from its underground position. Such a lining can be significantly more economical to install as compared with the removal and replacement of the single-walled tank with a new double-walled tank.

Historically, this liner has been a flexible bladder to allow for installation in situ in a prepositioned, and generally underground, storage tank. The bladder is placed into the empty tank and is then expanded to fill the internal area inside the tank. The liquid to be placed into the tank is then actually inserted into the bladder. As the bladder conforms to the internal space of the original outer tank, a double wall tank is created with the bladder as the inner wall and the original outer tank as the outer wall.

In alternative arrangements, in order to avoid use of the flexible bladder which may tear, a rigid tank liner is used. A method of retrofitting tanks has been described in U.S. Pat. No. 5,904,265 (which is entirely incorporated herein by reference), which includes an inner lining comprising a flexible multi-layered fabric having an interstitial space between two generally parallel layers of fabric, the layers being supported at a distance from one another by generally perpendicular fabric pylons, all of which is reinforced and hardened by a resin polymerization once in place. An example of such a lining is that of the commercial product known as PARABEAM® (three dimensional glass fabric). One such retrofitted liner is sold under the name Phoenix™.

While these arrangements can be considered an improvement over the bladder as they produce a more rigid internal “tank” structure and they are more rigid systems that effectively serve to make a more unified double-walled tank structure, such systems are generally still dependent on the structural integrity of the outer (existing) tank being retained. The systems are not designed to be self-supporting.

In fact, traditional liner systems are generally incapable of acting as self-supporting structures as, to resist deformation, these products are dependent on the underlying walls of the outer (existing) tank to which they are attached retaining its structural integrity. Should the outer walls fail in these systems, generally, the liner may become detached from the tank and also fail. Accordingly there is a need in the art for, among other things, a self-supporting internal liner that can be installed into existing storage tanks, particularly into underground storage tanks.

### SUMMARY

Because of these and other problems in the art, discussed herein is a liner, a double-walled tank including such a liner, and a method for retrofitting or creating such a liner wherein the liner is designed to be self-supporting. Specifically, the liner is formed by adding structures to the inner surface of an existing single-walled or double walled tank which project from the inner surface of the tank into the internal volume. The combination of the surfaces of the structures and the remaining inner surfaces of the tank form a modified inner surface which then has a liner placed adjacent thereto. The liner is hardened or otherwise fixed in form to provide for an internal liner which retains negatives of the shapes of the structures and is capable of resisting deformation should the original tank be removed and the liner be filled with material that originally would occupy the tank. Thus, the liner is shaped by the inclusion of internal structures in the tank to alter its shape and improve its strength allowing it to lose dependency on the integrity of the outer tank for support.

There is described herein, in an embodiment, a double walled tank comprising: an outer wall having an inner surface surrounding an internal volume; a plurality of structures arranged on the inner surface which project into the internal volume, each of the structures also including a surface, the combination of the inner surface of the outer wall and the surfaces of the structures forming a modified inner surface; and a liner, the liner being positioned adjacent to the outer wall and the plurality of structures; wherein a shape of the liner corresponds to the modified inner surface.

In an embodiment of the tank the liner comprises two walls with an interstitial space therebetween. This liner may comprise a resin hardened material.

In an embodiment of the tank the outer wall is generally cylindrical and the structures include at least one rib arranged on a side of the cylinder, at least one partial sphere arranged on an end of the cylinder and/or at least one corner shape which alters the internal angle between the sides and the ends of the cylinder from being generally 90 degrees.

In an embodiment the tank is underground and may be used to store motor vehicle fuel. In an embodiment, the liner can retain the motor vehicle fuel without destructive deformation even when the outer wall and the structures are removed.

There is also described herein a method of retrofitting a single walled tank to a double walled tank, the method comprising: providing a single walled tank having an outer wall with an inner surface surrounding an internal volume; arranging a plurality of structures on the inner surface which project into the internal volume, each of the structures also including a surface, the combination of the inner surface of the outer wall and the surfaces of the structures forming a modified inner surface; positioning a flexible liner in the single walled tank, the flexible liner being adjacent to a portion of the outer wall and the plurality of structures so a shape of the liner corresponds to the modified inner surface; and hardening the flexible liner so as to make the flexible liner rigid.

In an embodiment of the method the liner comprises two walls with an interstitial space therebetween and the hardening may comprise coating the liner with resin.

In an embodiment of the method the outer wall is generally cylindrical and the structures include at least one rib arranged on a side of the cylinder, at least one partial sphere arranged on an end of the cylinder and/or at least one corner shape which alters the internal angle between the sides and the ends of the cylinder from being generally 90 degrees.

In an embodiment of the method the single walled tank is underground and all the steps are performed without removing the tank from underground.

### BRIEF DESCRIPTION OF THE DRAWINGS

FIG. 1 provides a cut-through drawing of a rib structure in place on the inner wall of an existing outer tank.

FIG. 2 provides a cut-through drawing showing the rib of FIG. 1 in conjunction with a portion of the liner being placed thereon.

FIG. 3 provides for a partial side view of a self-supporting tank liner including the negative structures formed by the ribs and related structures placed on the inner surfaces of the existing tank walls.

FIG. 4 provides for a partial end cut-through view of a self-supporting tank liner in place inside the volume of an existing tank. The ribs and other structures positioned to form its shape are also present.

### DETAILED DESCRIPTION OF PREFERRED EMBODIMENT(S)

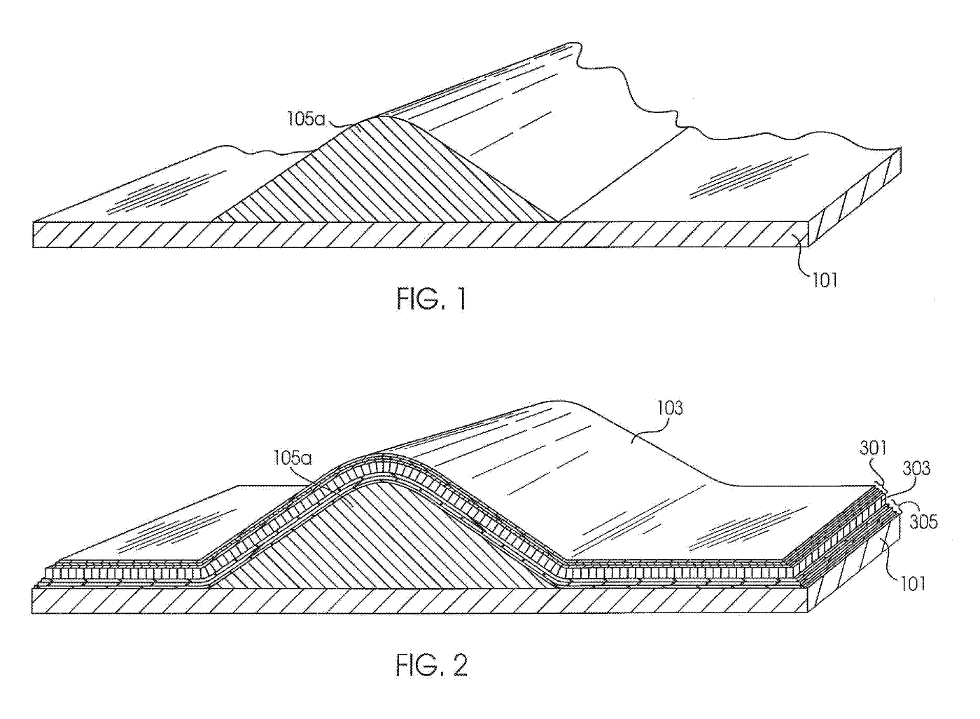

Different embodiments of the self-supporting internal liner and double-walled tank including such a liner are specifically described with respect to FIGS. 1-4. Generally, the system described herein is intended for use in conjunction with an existing storage tank to make it into a double-walled storage tank (or a tank having any number of walls more than one). A “self-supporting” liner as contemplated herein is generally a liner that is not dependent on the integrity (or even existence) of the existing tank outer wall to support it. Instead, a self-supporting liner can effectively be considered a functional tank even if the entire existing tank was removed.

Specifically, the liner is formed by adding structures to the inner surface of an existing single-walled or double walled tank which project from the inner surface of the tank into the internal volume. The combination of the surfaces of the structures and the remaining inner surfaces of the tank form a modified inner surface which then has a liner placed adjacent thereto. The liner is inserted (generally in a flexible form incapable of acting as a tank and is then hardened or otherwise fixed in form to provide for an internal liner which retains negatives of the shapes of the structures and is capable of resisting deformation due to this shape. Thus, the liner is generally shaped by the inclusion of internal structures in the tank and is adhered to the structures and inner tank surface, but is much stronger and less prone to deformation due to changes in internal pressure than a standard liner construction.

In many embodiments, the existing tank will comprise an underground storage tank such as those commonly used at gas stations and related facilities for the storage of automotive fuel. However this should not be seen as limiting as it is contemplated that, in other embodiments, the system described herein may be utilized with newly manufactured storage tanks prior to their insertion in the ground or with storage tanks for storing other materials.

In some embodiments, the existing tank will generally be of a single wall design. In other words, the tank structure will comprise a single exterior surface or wall (101). The wall (101) will generally be manufactured from steel, fiberglass, or other materials as would be known to those of ordinary skill in the art. The tank will also be generally cylindrical in shape generally having a smoothly curving rounded side wall and two flat ends but that is by no means required and any shape of underground tank known to those of skill in the art is contemplated. In a traditional liner method, the liner would be installed directly onto an inner surface of the wall (101) and will comport with the shape of the wall (101) and thus would also be generally cylindrical (in the case of a cylindrical shaped tank).

The liners used will often be comprised of fabric or other flexible materials which may be hardened by the inclusion of hardening resins or other materials. In a preferred embodiment, the liner will comprise a double-walled liner which comprises two walls separated by an interstitial space. This includes, but is not limited to PARABEAM® (three dimensional glass fabric). One retrofitted liners of such material such as that is sold under the name Phoenix™. These liners will generally work by having their outer wall adhere to the inner surface of the tank, and then will create an interstitial space between the two walls or layers of the liner. This is as opposed to having the space be between the liner and the tank. Alternatively, a single wall liner may be used where the interstitial space is between the liner and the inner surface of the tank.

When a liner is constructed which is of cylindrical shape (or other shape which comports to the shape of the underground storage tank), the liner is expected to have insufficient structural integrity to be self-supporting. In particular, should the outer wall (101) (the tank) be removed, the liner construct would generally collapse under the standard operating conditions of an underground tank. Thus, the traditional liner is dependent on the outer wall (101) maintaining structural integrity for the liner to retain structural integrity. Stated differently, the liner cannot function as an underground tank for the storage of fluids on its own. This is common because liners are usually made to line existing tanks and therefore are made of materials which lack sufficient strength and rigidity, even when made more rigid through solidification and hardening techniques to stand alone. Further, liners are often made of flexible materials to enable them to be inserted through the small access openings in an underground tank allowing them to be placed in situ.

As can be seen in FIG. 1, an embodiment of a self-supporting liner (103) is formed by first constructing a series of structures (105) on the inside surface of the wall (101) of the existing tank which are used to impart structure onto a multilayer liner (103) which is installed over the surface structures (105) and inner surface of the wall (101). Effectively, the inclusion of the structures (105) provides a modified inner surface formed from the surfaces of the structures (105) and the remaining, uncovered, portion of the outer wall (101).

The surface structures (105) are not intended to provide actual components of the liner (103), but are instead designed to impart shape to the liner (103) which shape allows it to survive the mechanical stresses (at least for a desirable limited period of time) which would normally be encountered in an underground storage tank. Thus, should the outer wall (101) prove to be the source of a failure, the liner (103) can retain the liquid internally acting as a self-supporting double-wall container (in the event that the liner comprises a double-wall structure), without concern that the outer wall (101) failure will result in the liner (103) also suffering a catastrophic failure. The liner is thus self-supporting and also forms a double-walled tank even without presence of the outer wall (101).

Specifically, the shape imparted to the liner (103) by the structures (105) will generally inhibit the liner (103) from collapsing, folding, or bending, (and therefore possibly tearing) should the liner become detached from at least a portion of the inner surface of the tank outer wall (101). Instead, the liner can operate on its own as a self supporting tank should the outer wall (101) be removed.

Generally, the structures (105) will be of three general shapes. There will be ribs (105a) which will be formed as rings around the inside of the side wall of the cylinder of the outer wall (101). There will also be a partial sphere (or similar shape such as, but not limited to, a hemisphere or parabolloid) (105b) which will be positioned on each of the flat ends of the cylinder of the outer wall (101). These end shapes (105b) will generally be centered on the flat end surfaces of the cylinder. Finally, there will be corner shapes (105c) which will be generally positioned at the intersection between the side and end walls (101) of the existing cylinder. These corner shapes will serve to alter the internal angle between the side and ends (which in a cylinder is generally a 90 degree intersection) into a smooth concave curve. Further, any other suitable structures known to those of ordinary skill in the art for imparting a shape to the inner liner that will increase its integrity are contemplated in this application. As can be seen the shapes will generally comprise smoothly curved surfaces as curving surfaces are generally more resistant to internal pressure changes than linear surfaces, which generally include weak points.

These internal structures (105) will generally be formed outside of the tank and will comprise a plastic foam or other similar material known to those of ordinary skill in the art. The structures (105) are generally intended to be light and inexpensive in their construction. In order to facilitate placement inside the tank they may be fabricated, in an embodiment, in a number of smaller pieces which can be connected to form the structures (105) as they are installed. The structures (105) will generally be adhered to the tank walls (101) once the tank has been appropriately cleaned. They may be adhered by any method known to those of ordinary skill in the art, but glue and similar chemical adhesives will generally be preferred. In another embodiment, the structures may be totally formed in situ, but this will generally only be preferred when the tank is an odd or unsupported shape.

As should be clear, when the various structures (105) have been positioned on the interior of the walls (101), the interior volume of the tank walls (101) has been altered and the shape is substantially different. This is illustrated in the partial section of FIG. 1 which shows the wall (101) with the rib (105a) attached thereto and therefore provides a portion of the modified inner surface. Effectively, this “new” interior surface (which comprises in part the inner surface of the tank and a surface formed by the structures adhered thereto) will act as a mold for the resin liner (103) and is referred to herein as the modified inner surface. Onto this newly altered interior surface a liner (103) will be placed as shown in FIG. 2. The liner (103) may be any form of liner known to those of ordinary skill in the art but will generally comprise a multi-wall liner which may also include an interstitial space between its walls which is capable of being hardened through the use of a resin or other material. In FIG. 2. the liner (103) comprises a three-layer laminate and resin surface (301) as the first wall which is placed onto an interstitial media (303) such as, but not limited to, PARABEAM®. This is then placed onto another 3 layer laminate and resin surface (305) forming a second wall. The resin and laminate surfaces will be allowed to cure and the resulting structure will be generally rigid. The interstitial space of media (303) may include interstitial monitoring apparatus such as, but not limited to, those described in U.S. Pat. No. 7,392,690 the entire disclosure of which is herein incorporated by reference.

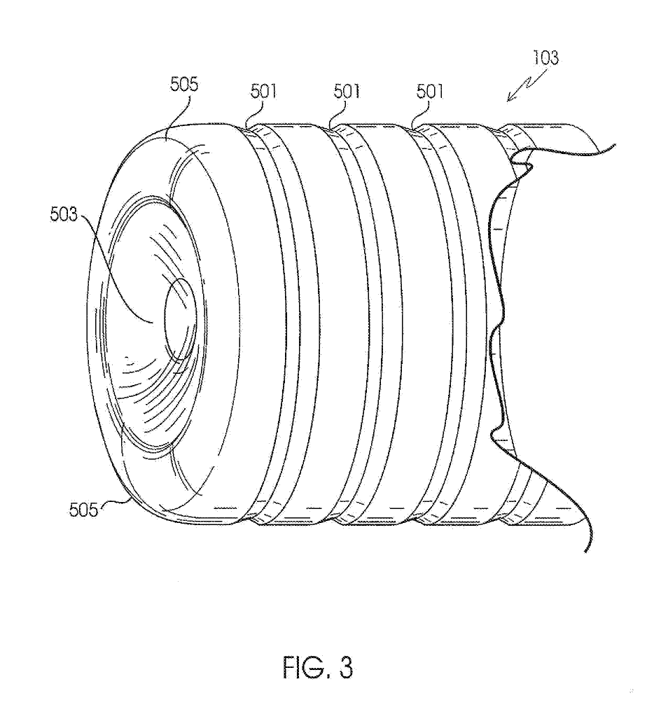

As can be seen in FIG. 2, the liner (103) will generally conform its wall shape to the modified inner surface of the wall (101) and structures (105) and will thus form a shape which is still generally the shape of the overall tank (in the case of a cylindrical tank, a cylindrical shape), but now includes interior surface features. Specifically, the resultant liner will include indents and other negative structural effects where the structures (105) are positioned. FIG. 3 shows an embodiment of a portion of the liner (103) as it may appear with the wall (101) and structures (105) completely removed. This is the component which is referred to herein as a self-supporting liner (103). It is important to recognize that the liner (103), as is visible in FIG. 3, does not include the structures (105) but does include negative spaces which correspond to the locations that those structures (105) occupied on the inner surface of the wall (101) when the liner was hardened. However, because it is generally undesirable to remove the structures after the liner has been solidified, the structures (105) will generally be retained between the outer wall (101) and the liner (103). The negative structures formed in the liner include, but are not limited to, the recessed ribs (501), the concave base (503) and the smoothly curving corners (505) which are formed from ribs (105a), end structure (105b), and corner structures (105c) respectively.

It is important to recognize that in the depicted embodiment the structures (105) are not necessary for structural strength or integrity of the self-supporting liner (103) and need not be a part of the self-supporting liner (103) although simply due to the structure and formation of the liner (103) they may be attached to the liner and present in the tank. Instead, the structures (105) serve mostly as “formers” or mold parts for the formation of the self-supporting liner (103) with the wall of the tank (106) providing the remaining structure. While the structures (105) are effectively sealed between the wall (101) and the liner (103) when the liner (103) is constructed and are generally not removable, they are not intended to be necessary for the liner (103) to retain its self-supporting nature. However, in an embodiment, they may impart additional strength to the liner and/or tank. Instead, the structures (105) will generally serve to give the liner (103) a resultant shape, which shape provides additional strength to allow the liner (103) to better resist deformation than would be the case if the structures (105) were not used. Once the liner (103) has been formed, the structures (105) are generally extraneous and are not required for the self-support of the liner (103).

As should be apparent from FIG. 3, the various negative recesses (501), (503) and (505) all serve to provide for strength for the liner (103). In normal operation, the interior and interstitial spaces of the liner may be exposed to negative and or positive pressure conditions which will serve to try and deform the liner (103). The negative recesses (501), (503) and (505), like those of many traditional plastic or metal containers (such as the cans and bottles used for carbonated beverages or with vacuum or hot packing techniques), are designed to provide strength to the liner (103) by providing it with resistance to deformation due to the shapes imparted by the structures (105). In particular, the concave base (503) and rounded corners (505), like that of a soda can or container, can resist deformation of the ends of the liner from pressure changes. The indented ribs (501) can similarly resist deformation of the side walls from internal pressure changes in a manner common to plastic bottle construction.

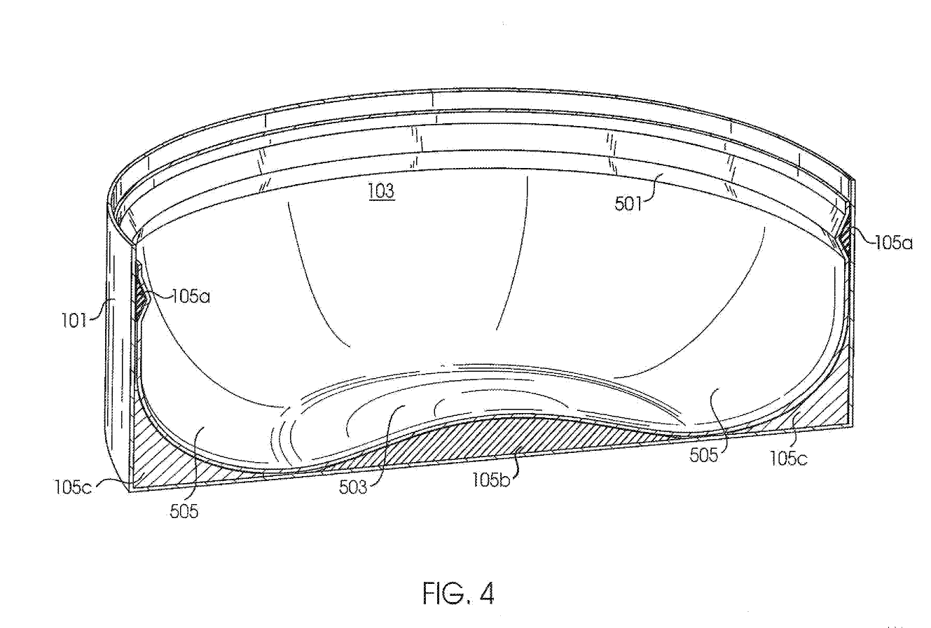

FIG. 4 provides for an embodiment of liner (103) as it may appear in place in an underground storage tank (101). The tank walls (101) initially define an internal space of generally cylindrical volume. Into that space are placed the structures (105) which serve to alter the surface of that interior volume. Against these structures, as well as portions of the outer wall (101), the liner (103) is applied. The liner (103) will then comport to the available inner surface in order to form a structure such as that shown in FIG. 3.

Once the entire structure of FIG. 4 has been constructed, the structure will generally provide for improved safety in a double-walled tank. While the double walls of liner systems generally do not utilize the walls (101) as one of the walls, but are effectively the two layers of resin (301) and (305) with the interstitial media layer (303) forming the monitorable space between, traditional designs were still reliant upon the integrity of the tank's walls (101) in order to maintain integrity of the inner liner of the double-walled tank as otherwise breaks or points of weakness in the outer wall (101) can result from the liner (103) collapsing upon itself. For example, the liner may have been held in place by a vacuum formed between the liner (103) and the outer wall (101). A breach in the outer wall (101) would inhibit the formation of the vacuum and therefore the liner (103) may collapse. As a traditional liner was simply a covering on the inside of the tank which allowed for the covering of an interstitial space between the liner and tank (or within the liner) the two pieces (tank and liner) effectively opened as interconnected parts of a singular object.

In the present arrangement, the liner (103) when arranged as shown in FIG. 3, can provide for a self-supporting structure which is capable of being its own tank and can operate as a double-wall tank even if the wall (101) (and the structures (105)) were to be completely removed. Because the liner (103) is arranged so as to be able to be self-supporting without the wall (101) at all, should the wall (101) suffer a failure, it should be apparent that the failure will not necessarily be translated to failure of the liner (103) or of the system as a whole. Instead, the system discussed herein effectively provides for two complete containment systems which are placed one within the other. As either system (liner or tank) can effectively act as, at least, a single wall system on its own, and generally the liner can act as a double-walled system on its own, the resultant combination is significantly safer.

The self-supporting tank liners (103) discussed herein can be formed in situ within an existing tank, such as an underground storage tank. In an embodiment, they are formed by first draining the existing tank of any material it may include. The tank may then be cleaned, as necessary. The internal structures (105) are then brought in and attached to the inner surface of the tank's walls (101).

Once the structures (105) are in place, the liner (103) material (as sheets, patches, or as a single unit) may be placed within the tank and generally positioned adjacent the walls (101) and structures (105). Once in position, resin can be applied to the laminate material and allowed to cure or other processes may be performed to form and hardening the wall(s) of the inner tank. This will harden the structure of the liner (103) and produce a generally rigid structure. Depending on the interstitial media used, an interstitial space (303) may also be formed by the resin application and curing process which is within the liner material.

Once resin application and curing has been completed, the self-supporting liner (103) has effectively been formed. In order to place the tank back into service, monitoring equipment will generally be positioned so as to monitor the interstitial space (303). The tank can then be refilled with liquid.

Depending on embodiment, the outer tank (101) will generally be left in place as the tank (101) effectively is already positioned underground and would be difficult to remove and the walls (101) do provide further reassurance against leaks above and beyond the liner (103), even though they are technically unnecessary to form a double-walled tank in the depicted arrangement. However, in alternative embodiments, the tank (101) could be removed after the liner (103) has been completely formed. Thus, the tank (101) acts essentially as a mold for the new self-supporting liner, which then becomes a stand alone tank located within the tank (101). As should be seen, the resultant double-walled tank structure is sturdier and generally safer than either tank alone. While both tanks are self-supporting, they are generally adhered together and therefore derive mutual benefit and strength from the arrangement.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A double walled tank comprising:
an outer wall having an inner surface surrounding an internal volume;
a plurality of structures arranged on said inner surface which project into said internal volume, each of said structures also including a surface, the combination of the inner surface of the outer wall and the surfaces of the structures forming a modified inner surface; and
a liner, said liner being positioned adjacent to said outer wall and said plurality of structures;
wherein a shape of said liner corresponds to said modified inner surface.

2. The tank of claim 1 wherein said liner comprises two walls with an interstitial space therebetween.

3. The tank of claim 2 wherein said liner comprises a resin hardened material.

4. The tank of claim 1 wherein said outer wall is generally cylindrical.

5. The tank of claim 4 wherein said structures include at least one rib arranged on a side of said cylinder.

6. The tank of claim 5 wherein said structures include at least one partial sphere arranged on an end of said cylinder.

7. The tank of claim 6 wherein said structures include at least one corner shape which alters the internal angle between said sides and said ends of said cylinder from being generally 90 degrees.

8. The tank of claim 4 wherein said structures include at least one partial sphere arranged on an end of said cylinder.

9. The tank of claim 4 wherein said structures include at least one corner shape which alters the internal angle between said sides and said ends of said cylinder from being generally 90 degrees.

10. The tank of claim 1 wherein said tank is underground.

11. The tank of claim 10 wherein said tank is used to store motor vehicle fuel.

12. The tank of claim 11 wherein said liner can retain said motor vehicle fuel without destructive deformation even when said outer wall and said structures are removed.

13. A method of retrofitting a single walled tank to a double walled tank, the method comprising:
providing a single walled tank having an outer wall with an inner surface surrounding an internal volume;
arranging a plurality of structures on said inner surface which project into said internal volume, each of said structures also including a surface, the combination of the inner surface of the outer wall and the surfaces of the structures forming a modified inner surface;
positioning a flexible liner in said single walled tank, said flexible liner being adjacent to a portion of said outer wall and said plurality of structures so a shape of said liner corresponds to said modified inner surface; and
hardening said flexible liner so as to make said flexible liner rigid.

14. The method of claim 13 wherein said liner comprises two walls with an interstitial space therebetween.

15. The method of claim 14 wherein said hardening comprises coating said liner with resin.

16. The method of claim 13 wherein said outer wall is generally cylindrical.

17. The method of claim 16 wherein said structures include at least one rib arranged on a side of said cylinder.

18. The method of claim 17 wherein said structures include at least one partial sphere arranged on an end of said cylinder.

19. The method of claim 18 wherein said structures include at least one corner shape which alters the internal angle between said sides and said ends of said cylinder from being generally 90 degrees.

20. The method of claim 13 wherein said single walled tank is underground and all said steps are performed without removing said tank from underground.
